(19) United States
(12) Patent Application Publication
(10) Pub. No.: US 2026/0241617 A1
(43) Pub. Date: Aug. 20, 2026

(54) METHOD FOR VAPORLESS PROCESSING OF EXPANDABLE FOR EXPANDED PARTICLE FOAM MATERIAL

(71) Applicant: FOX VELUTION GMBH, Burgbernheim (DE)

(72) Inventors: Jörg VETTER, Münster (DE); Mirjam Martina LUCHT, Burgbernheim (DE)

(21) Appl. No.: 18/870,201

(22) PCT Filed: May 24, 2023
(86) PCT No.: PCT/EP2023/063946

§ 371 Date: Nov. 27, 2024

(30) Foreign Application Priority Data
May 28, 2022 (DE) 10 2022 113 473.3

(51) Int. Cl. B29C 44/44; B29C 44/34; B29C 44/60

(52) U.S. Cl. CPC B29C 44/445; B29C 44/3415; B29C 44/60

(57) ABSTRACT

A method for vapor-free processing of expandable or expanded particle foam material for producing a particle foam preform in a molding tool cavity of a molding tool.

The invention relates to a method for vapor-free processing of expandable or expanded particle foam material for producing a particle foam preform in a molding tool cavity of a molding tool, comprising the steps of: filling a molding tool cavity of a molding tool for vapor-free processing of expandable or expanded particle foam material with an expandable or expanded particle foam material, and carrying out at least one measure for introducing, in a vapor-free manner, thermal energy into the expandable or expanded particle foam material filled into the molding tool cavity for forming a particle foam preform by means of a temperature-control device associated with the molding tool.

Corresponding methods for vapor-free and thus dry processing of expandable or expanded particle foam material for producing a particle foam preform in a molding tool cavity of a molding tool are known in principle from the prior art.

Corresponding methods are known to be distinguished from conventional superheated steam-based methods for processing expandable or expanded particle foam material for producing a particle foam preform in particular in that the thermal energy required for connecting the expandable or expanded particle foam material filled into the molding tool cavity is typically introduced into the expandable or expanded particle foam material largely conductively, i.e. predominantly in a manner based on thermal conduction, and thus without the use of superheated steam flowing through the molding tool cavity.

Even if vapor-free methods make it possible to produce particle foam preforms having very good properties, in a reproducible and thus reliable manner, it is desirable to further improve the vapor-free methods. In this case, the vapor-free methods are intended to be further improved in particular with respect to aspects such as efficiency and controllability of the production process, as well as quality of the producible particle foam preforms.

The object of the invention is therefore that of specifying an improved method for vapor-free processing of expandable or expanded particle foam material for producing a particle foam preform in a molding tool cavity of a molding tool.

The object is achieved by a method for vapor-free processing of expandable or expanded particle foam material according to independent claim 1. The claims dependent thereon relate to possible embodiments of the method according to independent claim 1.

A first aspect of the invention relates to a method for vapor-free and thus dry processing of expandable or expanded particle foam material (referred to for short in the following as “particle foam material”) for producing a particle foam preform in a molding tool cavity of a molding tool. The method accordingly relates to the vapor-free and thus dry processing of particle foam material in a molding tool cavity of a molding tool for producing a particle foam preform. The terms “vapor-free” and/or “dry” mean that the thermal energy required for connecting the particle foam material to form the particle foam preform is introduced into the particle foam material conductively, in particular exclusively conductively, or in a mixed conductive/convective manner, in particular exclusively in a mixed conductive/convective manner, and thus in any case without the use of superheated steam flowing through the molding tool cavity.

The method is thus carried out using a molding tool configured for vapor-free and thus dry processing of particle foam material. The molding tool comprises at least one molding tool element, which defines a molding tool cavity of the molding tool. The at least one molding tool element, which can optionally also be referred to as a molding tool wall or molding tool wall portion, is typically mounted so as to be movable between an open position, in which, e.g. for the purpose of removing a produced particle foam preform, there is a possibility of access into the molding tool cavity, and a closed position in which—apart from possibly required small required openings e.g. for ventilation—there is no possibility of access into the molding tool cavity. The molding tool can comprise a plurality of molding tool elements, optionally also referred to as molding tool halves, which together define the molding tool cavity. If the molding tool comprises a plurality of molding tool elements, at least one molding tool element can be mounted so as to be movable relative to at least one other molding tool element, in order to achieve a corresponding open and closed position.

The molding tool is, as mentioned, configured for vapor-free and thus dry processing of particle foam material. The molding tool is accordingly associated with a temperature-control device which is configured to introduce the thermal energy, required for connecting the particle foam material to form the particle foam preform, into the particle foam material conductively, in particular exclusively conductively, or in a mixed conductive/convective manner, in particular exclusively in a mixed conductive/convective manner, and thus in any case without the use of superheated steam flowing through the molding tool cavity. The molding tool correspondingly does not have a vapor chamber, in which superheated steam can be kept for flowing through the molding tool cavity. The wall portions of the molding tool defining the molding tool cavity, or the wall portions of the molding tool element(s) defining the molding tool cavity, thus likewise do not have any passage openings for the passage of superheated steam into the molding tool cavity.

As emerges in the following, a corresponding temperature-control device can be formed by or comprise e.g. a flow channel structure through which a temperature-control medium, e.g. a gas and/or a liquid, can flow. A corresponding flow channel structure can comprise one or more flow channels which extend in one or more spatial planes and/or directions outside or inside the molding tool, i.e. in particular outside or inside at least one molding tool element. During operation of a correspondingly configured temperature-control device, an, optionally pressurized, temperature-control medium can flow through the flow channel structure, which results in temperature control of the wall portions of the molding tool defining the molding tool cavity, such that thermal energy can be transferred into the molding tool cavity and thus to the particle foam material located in the molding tool cavity via the wall portions of the molding tool defining the molding tool cavity. Depending on the temperature level of the temperature-control medium, the molding tool cavity or the particle foam material can be heated or, this applies in particular for a previously heated molding tool cavity, cooled, in this way. Therefore, the at least one measure for introducing, in a vapor-free manner, thermal energy into the particle foam material filled into the molding tool cavity for forming a particle foam preform, which is described in more detail below and is carried out in the context of the method, can be carried out by means of a heated temperature-control medium flowing through a flow channel structure. As mentioned, according to the method the thermal energy required for connecting the particle foam material to form the particle foam preform is introduced into the particle foam material in a vapor-free manner and thus conductively, in particular exclusively conductively, or in a mixed conductive/convective manner, in particular exclusively in a mixed conductive/convective manner, and thus in any case without the use of superheated steam flowing through the molding tool cavity.

The steps of the method are explained in detail in the following:

The method comprises a step of filling the molding tool cavity of the or a molding tool for vapor-free processing of particle foam material with an expandable or expanded particle foam material. The filling of the molding tool cavity with a particle foam material is carried out using a filling device associated with the molding tool, which device is configured for filling the molding tool cavity with particle foam material. A corresponding filling device can e.g. be configured for generating an, optionally pressurized, conveying stream, i.e. in particular a gas stream, via which the particle foam material is conveyed, optionally pressurized, into the molding tool cavity. Accordingly, a corresponding filling device can comprise one or more filling portions which communicate with the molding tool cavity and via which particle foam material can be conveyed into the molding tool cavity.

Furthermore, the method comprises a step of carrying out at least one measure for introducing, in a vapor-free manner, thermal energy into the particle foam material filled into the molding tool cavity for forming a particle foam preform. Accordingly, so much thermal energy is introduced, via the at least one measure, into the particle foam material filled into the molding tool cavity, that the plastics particles are interconnected, in particular by what is known as fusing, forming the particle foam preform to be produced. The at least one measure for introducing, in a vapor-free manner, thermal energy into the particle foam material filled into the molding tool cavity for forming a particle foam preform is carried out by means of a temperature-control device associated with the molding tool. As mentioned above, according to the method typically a temperature-control device is used which is configured to introduce the thermal energy, required for connecting the particle foam material filled into the molding tool cavity to form the particle foam preform, into the particle foam material conductively, in particular exclusively conductively, or in a mixed conductive/convective manner, in particular exclusively in a mixed conductive/convective manner, and thus in any case without the use of superheated steam flowing through the molding tool cavity.

The method can further comprise a step of carrying out at least one measure for cooling the particle foam preform in the molding tool cavity by means of the or a temperature-control device associated with the molding tool.

The method further comprises a step of carrying out at least one measure for, in particular pneumatically, controlling (the term “controlling” can also include “regulating”) the pressure in the molding tool cavity during the filling of the molding tool cavity with particle foam material and/or while carrying out the at least one measure for introducing, in a vapor-free manner, thermal energy into the particle foam material filled into the molding tool cavity for forming the particle foam preform and/or while carrying out the at least one measure for cooling the particle foam preform in the molding tool cavity.

The at least one measure for controlling the pressure (this can alternatively or additionally also be understood as regulation of the pressure) in the molding tool cavity during the filling of the molding tool cavity with the particle foam material and/or while carrying out the at least one measure for introducing, in a vapor-free manner, thermal energy into the particle foam material filled into the molding tool cavity for forming the particle foam preform and/or while carrying out the at least one measure for cooling the particle foam preform in the molding tool cavity is carried out by means of a pressure control device associated with the molding tool. The pressure control device is accordingly configured for carrying out at least one measure for controlling the pressure in the molding tool cavity during the filling of the molding tool cavity with particle foam material and/or while carrying out the at least one measure for introducing, in a vapor-free manner, thermal energy into the particle foam material filled into the molding tool cavity for forming the particle foam preform and/or while carrying out the at least one measure for cooling the particle foam preform in the molding tool cavity.

The term “pressure” refers, herein, to the gas pressure or the air pressure in the molding tool cavity or within the molding tool cavity.

The pressure control device is a device separate from the temperature-control device. It is therefore possible and also purposely provided according to the method, in particular during the filling of the molding tool cavity with the particle foam material and/or while carrying out the at least one measure for introducing, in a vapor-free manner, thermal energy into the particle foam material filled into the molding tool cavity for forming the particle foam preform and/or while carrying out the at least one measure for cooling the particle foam preform in the molding tool cavity, to control the pressure within the molding tool cavity independently of the temperature within the molding tool cavity (and vice versa). The carrying out of the at least one measure for controlling the pressure in the molding tool cavity thus takes place, according to the method, in particular independently of the carrying out of the at least one measure for introducing, in a vapor-free manner, thermal energy into the particle foam material filled into the molding tool cavity for forming a particle foam preform and/or independently of the carrying out of the at least one measure for cooling the particle foam preform in the molding tool cavity, even if the carrying out of the at least one measure for controlling the pressure in the molding tool cavity and the carrying out of the at least one measure for introducing, in a vapor-free manner, thermal energy into the particle foam material filled into the molding tool cavity for forming a particle foam preform and/or the carrying out of the at least one measure for cooling the particle foam preform in the molding tool cavity can take place at least sometimes in parallel.

A corresponding pressure control device can, as explained in more detail below, comprise a pressure reservoir filled e.g. with a pressurized pressure medium, in particular a pressurized gas, e.g. compressed air, and at least one pressure chamber that is configured in one or more parts, communicates therewith and is associated with the molding tool cavity, in particular surrounds the molding tool cavity at least in portions, optionally completely. A corresponding pressure chamber can communicate with the molding tool cavity e.g. via one or more openings (these can optionally also be implemented by porous wall portions), such that a pressure level prevailing within the pressure chamber, i.e. in particular a gas or air pressure level prevailing within the pressure chamber, can be transferred to the molding tool cavity and thus the particle foam material filled into the molding tool cavity. A corresponding pressure chamber can comprise one or more, in particular valve-like or valve-shaped, pressure control elements, which are configured for controlling an inflow of the or a pressurized pressure medium into the pressure chamber and/or for controlling an outflow of the or a pressurized pressure medium out of the pressure chamber. As is also explained in more detail below, the pressure control device is typically associated with a controller which is implemented by hardware and/or software and which is configured for controlling the operation of the pressure control device and thus the pressure level within the molding tool cavity.

The method is thus characterized by the possibility, which can be or is achieved by means of the pressure control device, of purposely creating and maintaining particular pressure levels, i.e. in particular gas or air pressure levels, within the molding tool cavity, irrespective of the temperature within the molding tool cavity. As emerges in the following, according to the method particular pressure changes or distributions, i.e. in particular gas pressure changes or distributions, can be purposely created and maintained within the molding tool cavity irrespective of the temperature within the molding tool cavity, in particular in a time-dependent manner, which surprisingly has an extremely positive effect on the processes occurring within the molding tool cavity, in the context of the method, i.e. e.g. the filling process in which the molding tool cavity is filled with particle foam material, and/or the temperature-control process in which the particle foam material filled into the molding tool cavity is temperature-controlled, i.e. in particular heated and/or cooled. In other words, the purposeful setting of corresponding pressure levels or distributions in the molding tool cavity, which optionally vary in a process-dependent and thus time-dependent manner, makes it possible to purposely influence the processes occurring within the molding tool cavity in the context of the method, and thus the properties of the particle foam preform to be produced. The possibility, which can be or is achieved by means of the pressure control device, of purposely creating and maintaining particular pressure levels or distributions within the molding tool cavity, irrespective of the temperature within the molding tool cavity, thus opens entirely new possibilities of process control, which has a positive effect on the efficiency and controllability of the method and on the quality of the particle foam preforms that can be produced according to the method.

The method accordingly implements purposeful pressure management within the molding tool cavity and makes use of the finding that the particle foam material, in particular owing to its porous or cellular structure and/or the loading with compressed air and/or a propellant, can be expanded and compressed, i.e. has a certain expansion and compression capacity. This expansion or compression capacity enables not only purely mechanical deformation of the particle foam material, but rather a deformation that is meaningful for the principle described herein by a purposeful increase or reduction in the pressure, which, as mentioned, is to be understood as the gas or air pressure, in the molding tool cavity. In this case, the deformation of the particle foam material resulting from a corresponding change in the pressure in the molding tool cavity can be elastic and thus reversible, or plastic and thus irreversible. The latter applies in particular if the particle foam material is of a particular temperature, i.e. typically a temperature above a material-specific softening point.

This results in an improved method for vapor-free processing of expandable or expanded particle foam material for producing a particle foam preform in a molding tool cavity of a molding tool.

The method typically comprises further processes or steps in addition to the mentioned steps or processes of filling the molding tool cavity with particle foam material and carrying out the at least one measure at least one measure for introducing, in a vapor-free manner, thermal energy into the particle foam material filled into the molding tool cavity for forming a particle foam preform by means of a temperature-control device associated with the molding tool.

These include for example the above-mentioned step of carrying out at least one measure for cooling the particle foam preform in the molding tool cavity by means of the or a temperature-control device associated with the molding tool. Therefore, in the context of the method, after the formation of the particle foam preform by the at least one measure for introducing, in a vapor-free manner, thermal energy into the particle foam material filled into the molding tool cavity for forming a particle foam preform by means of a temperature-control device associated with the molding tool, typically at least one measure for cooling the particle foam preform in the molding tool cavity is carried out, by means of the or a temperature-control device associated with the molding tool. The at least one measure for cooling the particle foam preform in the molding tool cavity can accordingly be carried out e.g. by means of a (comparatively) cool(er) temperature-control medium flowing through the flow channel structure.

The at least one measure for controlling the pressure in the molding tool cavity can also be carried out while carrying out the at least one measure for cooling the particle foam preform in the molding tool cavity by means of the pressure control device associated with the molding tool. Here, too, it is the case that the carrying out of the at least one measure for controlling the pressure in the molding tool cavity can take place independently of the carrying out of the at least one measure for cooling the particle foam preform in the molding tool cavity. Therefore, the pressure level within the molding tool cavity while carrying out the at least one measure for cooling the particle foam preform in the molding tool cavity can be entirely independent of the cooling processes; in this way, the properties of the particle foam preform that is to be produced or has been produced can be influenced in a targeted manner, e.g. by targeted depressurization of the particle foam material and a resulting expansion.

The at least one measure for introducing, in a vapor-free manner, thermal energy into the molding tool cavity can take place already before and/or during the filling of the molding tool cavity with a particle foam material. Therefore, the molding tool cavity can be thermally preconditioned by the introduction, in a vapor-free manner, of thermal energy already before and/or during the filling of the molding tool cavity, which can have a positive effect on the filling process and/or the subsequent temperature-control process, and thus on the properties of the particle foam preform that is to be produced or that has been produced. The at least one measure for introducing, in a vapor-free manner, thermal energy into the molding tool cavity can be carried out before and/or during the filling of the molding tool cavity, e.g. by means of the temperature-control device associated with the molding tool. Alternatively or in addition, a temperature control of a conveying stream generated by the filling device, by means of which the particle foam material is conveyed into the molding tool cavity, is conceivable.

As indicated, the at least one measure for controlling the pressure in the molding tool cavity can be carried out by purposeful introduction of a pressurized pressure medium, i.e. e.g. a pressurized gas, such as compressed air, into the molding tool cavity. Likewise, the at least one measure for controlling the pressure in the molding tool cavity can be carried out by purposeful removal or release of a pressurized medium from the molding tool cavity, in particular after a corresponding introduction of a pressurized pressure medium into the molding tool cavity.

The pressure medium introduced into the molding tool cavity via the pressure control device can also be temperature-controlled, such that thermal energy can also be introduced into the molding tool cavity via the pressure medium, in addition to, although independently of, the actual measures for introducing thermal energy into the particle foam material, for example for preconditioning the particle foam material. The at least one measure for controlling the pressure in the molding tool cavity can accordingly include at least intermittently introducing a pressurized pressure medium, which is temperature-controlled by means of an active or passive temperature-control measure to a heating or cooling temperature, into the molding tool cavity. The temperature-control measure can be carried out by at least one temperature-control device that is associated with the pressure control device. This is typically a temperature-control device that is separate from the temperature-control device associated with the molding tool.

As indicated, the pressure control device is typically associated with a controller which is implemented by hardware and/or software and which is configured for controlling the operation of the pressure control device and thus the pressure level within the molding tool cavity. The carrying out of the at least one measure for controlling the pressure in the molding tool cavity can thus be carried out on the basis of control information generated by the controller implemented by software and/or hardware, which allows for accurate and reproducible and individualizable control of the pressure level within the molding tool cavity.

The method can further contain a step of detecting at least one chemical and/or physical parameter, i.e. in particular the pressure, the temperature, the composition of the chemical atmosphere, within the molding tool cavity, and of generating an item of detection information describing the at least one detected chemical and/or physical parameter within the molding tool cavity. The step of detecting at least one chemical and/or physical parameter within the molding tool cavity and of generating an item of detection information describing the at least one detected chemical and/or physical parameter within the molding tool cavity can be carried out by means of a detection device associated with the molding tool cavity. A corresponding detection device can comprise one or more detection elements, i.e. e.g. sensor elements, e.g. pressure sensor elements, temperature sensor elements, etc., arranged or formed on or in the molding tool, the detection signals of which can be described by the detection device in corresponding detection information, which, as explained below, can be used for controlling the method.

Corresponding detection information can accordingly be used e.g. by a corresponding controller for controlling the operation of the pressure control device and thus for controlling the pressure level within the molding tool cavity. A corresponding controller can accordingly generate the control information that controls the operation of the pressure control device on the basis of or taking account of the detection information.

It has been mentioned that the method makes it possible, by means of the pressure control device, to purposely create and maintain particular pressure levels or pressure distributions within the molding tool cavity independently of all the measures for temperature-control of the molding tool cavity and thus of the particle foam material located therein.

This can be achieved e.g. such that a corresponding controller generates corresponding control information for controlling the operation of the pressure control device on the basis of pressure distribution information, i.e. e.g. gas pressure distribution information, stored in a data storage device, e.g. implemented as a server, which information in each case defines a defined pressure distribution, i.e. e.g. a gas pressure distribution, within the molding tool cavity. Therefore, a corresponding controller can have recourse to predefined pressure distribution information for controlling the operation of the pressure control device, which can reduce the complexity for the control of the operation of the pressure control device. Corresponding pressure distribution information may have been generated on the basis of information from databases, experiments, simulations, etc. Corresponding defined pressure distributions can describe in particular profile-like or profile-shaped pressure distributions, more particularly pressure distributions that rise or fall in a ramp-like or ramp-shaped manner, and/or, in particular plateau-like or plateau-shaped, pressure levels. In particular, respective defined pressure distributions can accordingly describe pressure levels that vary in a time-dependent manner.

Each pressure distribution can define an, e.g. time-dependent, change in a pressure level in the molding tool cavity and/or an, e.g. time-dependent, maintenance of a pressure level in the molding tool cavity. An, e.g. time-dependent, change in a pressure level in the molding tool cavity can define an increase in a pressure level, i.e. in particular an initial pressure level to a comparatively higher target pressure level, and/or a drop in a pressure level, i.e. in particular an initial pressure level to a comparatively lower target pressure level. Each pressure distribution can accordingly define a curve of a pressure level within the molding tool cavity that is predefinable or predefined, in particular time-dependent, in particular that can be described by a mathematical function.

Corresponding pressure distribution information can be stored in the data storage device e.g. in a manner ordered or categorized in a material and/or molding tool and/or preform-specific manner, such that e.g. particle foam materials that are to be processed differently, and/or molding tools that are configured differently e.g. with respect to the volume of the molding tool cavity, and/or particle foam preforms that are configured differently e.g. with respect to their geometric/structural configuration, can be assigned predefined pressure distribution information. In this way, material and/or molding tool and/or preform-specific differences can be considered when applying corresponding pressure distributions, and thus highly individualized or tailored pressure levels or pressure distributions can be implemented in view of a with a specific particle foam material in a specific molding tool for producing a specific particle foam preform.

A data storage device can be used, in which pressure distribution information which describes a defined pressure level in the molding tool cavity, which can optionally vary in a time-dependent manner, for a complete production process of a particle foam preform, is stored, such that a (single) item of pressure distribution information defines the pressure level within the molding tool cavity, which can optionally vary in a time-dependent manner, for a complete method procedure for producing a particle foam preform. Accordingly, at least one item of pressure distribution information can be stored in the data storage device, which defines a pressure distribution during the filling of the molding tool cavity with the particle foam material, while carrying out the at least one measure for introducing, in a vapor-free manner, thermal energy into the particle foam material filled into the molding tool cavity for forming a particle foam preform, while carrying out the at least one measure for cooling the particle foam preform the molding tool cavity, and while demolding the particle foam preform from the molding tool cavity.

The expansion or compression capacity described in the present case in connection with the particle foam material of course also applies for the particle foam preform formed from the particle foam material, such that its properties can also be purposely influenced by purposeful control of the pressure in the molding tool cavity.

In order to optionally achieve a higher level of granularity with respect to a setting of a pressure level in the molding tool cavity that is optimized in a process-dependent manner, separate pressure distribution information can be stored in the data storage device for individual ones of, a plurality of or all of the processes within the method. Accordingly, a plurality of separate items of pressure distribution information can be stored in the data storage device, wherein at least one item of pressure distribution information defines a pressure distribution during the filling of the molding tool cavity with the particle foam material, and/or at least one item of pressure distribution information defines a pressure distribution while carrying out the at least one measure for introducing, in a vapor-free manner, thermal energy into the particle foam material filled into the molding tool cavity for forming a particle foam preform, and/or at least one item of pressure distribution information defines a pressure distribution while carrying out the at least one measure for cooling a particle foam preform the molding tool cavity, and/or at least one item of pressure distribution information defines a pressure distribution while demolding a particle foam preform from the molding tool cavity.

Accordingly, at least one item of pressure distribution information can be stored in the data storage device (and be used by the pressure control device for controlling the pressure within the molding tool cavity), which defines a pressure distribution during the filling of the molding tool cavity with the particle foam material, which results in compression of the particle foam material filled into the molding tool cavity. The pressure distribution can define a first pressure level that is increased with respect to a reference pressure, e.g. atmospheric pressure (outside of the molding tool cavity), which pressure level is to be maintained during the filling of the molding tool cavity with the particle foam material. The compression of the particle foam material resulting from the increased pressure makes it possible for higher filling levels of the molding tool cavity to be achieved, which can e.g. have a positive effect on the properties of the particle foam preform to be produced. As emerges in the following, higher filling levels of the molding tool cavity can, however, also have a positive effect on the process of binding the plastics particles for forming the particle foam preform, which process follows the filling of the molding tool cavity, as the plastics particles contact one another more strongly “by necessity”.

Alternatively or in addition, at least one item of pressure distribution information can be stored in the data storage device (and can be used by the pressure control device for controlling the pressure within the molding tool cavity), which defines a pressure distribution while carrying out the at least one measure for introducing, in a vapor-free manner, thermal energy into the particle foam material filled into the molding tool cavity for forming a particle foam preform, which results in expansion of the particle foam material filled into the molding tool cavity. The pressure distribution can define a second pressure level that is increased with respect to a reference pressure, e.g. atmospheric pressure, but reduced with respect to the first pressure level (during the filling of the molding tool cavity), which second pressure level is to be maintained while carrying out the at least one method for introducing, in a vapor-free manner, thermal energy into the particle foam material filled into the molding tool cavity for forming a particle foam preform. The expansion of the particle foam material makes it possible for the contact surfaces and thus the surfaces for transmitting thermal energy between the individual plastics particles to be improved, as adjacent plastics particles press against one another due to expansion. This leads to an improved connection and fusing of the plastics particles, and thus to improved properties of the particle foam preform that is to be produced or has been produced. As indicated, the expansion brought about by a corresponding second pressure level is expediently preceded by a compression of the plastics particles brought about by a corresponding first pressure level. The second pressure level can also serve, during processing of particle foam material loaded with a chemical and/or physical propellant, for preventing undesired escape of the propellant or for reducing this, in particular in a pressure-controlled manner, i.e. in particular in a gas pressure-controlled manner.

Alternatively or in addition, at least one item of pressure distribution information can be stored in the data storage device (and can be used by the pressure control device for controlling the pressure within the molding tool cavity), which defines a pressure distribution while carrying out the at least one measure for cooling the particle foam preform in the molding tool cavity, which results in targeted cooling of the particle foam preform, in particular targeted formation of a defined microstructure of the particle foam preform, more particularly in the formation of a purposeful size and/or morphology of the plastics particles that are interconnected to form the particle foam preform. The pressure distribution can include at least one pressure level that is increased and/or reduced with respect to the second pressure level, such that the plastics particles can optionally compressed again or (further) expanded during cooling, which results in various possibilities for setting a defined microstructure or cell structure of the particle foam preform.

Alternatively or in addition, at least one item of pressure distribution information can be stored in the data storage device (and can be used by the pressure control device for controlling the pressure within the molding tool cavity), which defines a pressure distribution while demolding the particle foam preform from the molding tool cavity, which results in demolding, i.e. in particular simplified and/or quicker, demolding of the particle foam preform from the molding tool cavity, in particular the opened molding tool cavity. A corresponding pressure distribution can cause e.g. an in particular ramp-like or ramp-shaped pressure increase within the molding tool cavity, in order to release the particle foam preform from the wall portions of the molding tool that define the molding tool cavity.

As mentioned, according to the invention a pressure control device can be used which can comprise e.g. a pressure reservoir filled e.g. with a pressurized pressure medium, in particular a pressurized gas, e.g. compressed air, and a pressure chamber that communicates therewith and is associated with the molding tool cavity, in particular surrounds the molding tool cavity at least in portions, optionally completely. A corresponding pressure chamber can communicate with the molding tool cavity e.g. via one or more openings, such that a pressure level prevailing within the pressure chamber can be transferred to the molding tool cavity and thus the particle foam material filled into the molding tool cavity. A corresponding pressure chamber can comprise one or more, in particular valve-like or valve-shaped, pressure control elements, which are configured for controlling an inflow of the or a pressurized pressure medium into the pressure chamber and/or for controlling an outflow of the or a pressurized pressure medium out of the pressure chamber. Respective pressure control elements can be transferred into at least one open position in which an inflow of a pressurized pressure medium into the pressure chamber, or an outflow of a pressurized pressure medium out of the pressure chamber, is possible, and into at least one closed position, in which an inflow of a pressurized pressure medium into the pressure chamber, or an outflow of a pressurized pressure medium out of the pressure chamber, is not possible. Furthermore, at least one intermediate position located between a respective open position and a respective closed position can be implemented, such that pressure levels which optionally vary in a time-dependent manner can be set in a very purposeful manner in the pressure chamber.

It has been mentioned that a corresponding temperature-control device can be formed by or comprise e.g. a flow channel structure through which a temperature-control medium, e.g. a gas and/or a liquid, can flow. A corresponding flow channel structure can comprise one or more flow channels which extend in one or more spatial planes and/or directions outside or inside the molding tool, i.e. in particular outside or inside at least one molding tool element. Corresponding flow channels can, as mentioned, be formed by one or more channel-like or channel-shaped recesses formed in one or more spatial planes and/or directions through at least one wall of the molding tool elements defining the molding tool cavity. Alternatively or in addition, corresponding flow channels can be formed by one or more separate line elements which are in particular configured in one or more spatial planes and/or directions, are one-dimensional or multidimensional, and through which a temperature-control medium can flow, i.e. e.g. pipe or tube elements, which are arranged at or in at least one wall portion of the molding tool that defines the molding tool cavity.

In connection with the particle foam material processed according to the method, it is in principle the case that the particle foam material that can be or is processed according to the method typically has a particulate structure before it is processed. The particle foam material thus typically consists of a plurality of expandable or expanded plastics particles. Corresponding plastics particles can optionally be plastics particles that are not yet expanded and are optionally loaded with a chemical and/or physical propellant, pre-expanded plastics particles that are optionally loaded with a chemical and/or physical propellant residue, or largely expanded plastics particles that are optionally loaded with a chemical and/or physical propellant, optionally loaded with a chemical and/or physical propellant residue. For plastics particles that are not yet expanded, and also for pre-expanded plastics particles, it is the case that these are typically (further) expandable and thus can be (further) expanded in an expansion process. For (largely) expanded plastics particles, it is the case that these can typically not be expanded (significantly further). Specific examples for particle foam materials or plastics particles that can be processed according to the method are, in a non-exclusive list, expandable or expanded polyolefins, such as expandable or expanded polyethylene, expandable or expanded polypropylene, expandable or expanded polystyrene. In principle, all expandable or expanded thermoplastics, such as ePA, ePC, ePBT or ePET, are possible-whether these be based on crude oil/natural gas (“virgin”) or have recyclate fractions or also biogens (from renewable raw materials).

A further aspect of the invention relates to a device for carrying out vapor-free processing of expandable or expanded particle foam material for producing a particle foam preform. The device is in particular configured for carrying out the method according to the first aspect of the invention, and therefore all that has been stated in connection with the method in principle applies analogously for the device.

The device comprises at least one molding tool that defines a molding tool cavity and is intended for vapor-free processing of particle foam material, a filling device associated with the molding tool cavity which is configured for filling the molding tool cavity with an expandable or expanded particle foam material; and at least one temperature-control device which is associated with the molding tool and is configured for carrying out at least one measure for introducing, in a vapor-free manner, thermal energy into the particle foam material filled into the molding tool cavity for forming a particle foam preform and/or for carrying out at least one measure for cooling the particle foam preform in the molding tool cavity, and is characterized by a pressure control device which is associated with the molding tool and which is configured for carrying out at least one measure for controlling the pressure, i.e., as mentioned, in particular the gas pressure, in the molding tool cavity during filling of the molding tool cavity with the expandable or expanded particle foam material, and/or while carrying out the at least one measure for introducing, in a vapor-free manner, thermal energy into the particle foam material filled into the molding tool cavity for forming a particle foam preform, and/or while carrying out the at least one measure for cooling the particle foam preform in the molding tool cavity.

The pressure control device can comprise a pressure reservoir filled e.g. with a pressurized pressure medium, in particular a pressurized gas, e.g. compressed air, and a pressure chamber that is configured in one or more parts, communicates therewith and is associated with the molding tool cavity, in particular surrounds the molding tool cavity at least in portions, optionally completely. A pressure chamber configured in multiple parts can e.g. comprise a plurality of pressure chamber halves.

The pressure chamber can communicate with the molding tool cavity e.g. via one or more openings, such that a pressure level prevailing within the pressure chamber can be transferred to the molding tool cavity.

The device can further comprise a controller which is implemented by hardware and/or software and is configured for generating control information for controlling the operation of the pressure control device.

The device can comprise a detection device which is configured for detecting at least one chemical and/or physical parameter within the molding tool cavity and for generating detection information that describes the at least one detected chemical and/or physical parameter within the molding tool cavity, wherein the or a controller is configured for generating control information for controlling the operation of the pressure control device on the basis of or taking account of the detection information.

The device can further comprise a data storage device in which pressure distribution information, which in each case defines an in particular profile-like or profile-shaped pressure distribution within the molding tool cavity, is stored. The data storage device can be associated with the controller, such that the controller can access data stored in the data storage device and process said data.

At least one item of pressure distribution information can be stored in the data storage device, which defines a pressure distribution during the filling during the molding tool cavity with the expandable or expanded particle foam material, while carrying out the at least one measure for introducing, in a vapor-free manner, thermal energy into the particle foam material filled into the molding tool cavity for forming a particle foam preform, while carrying out the at least one measure for cooling the particle foam preform the molding tool cavity, and while demolding the particle foam preform from the molding tool cavity. Alternatively or in addition, a plurality of separate items of pressure distribution information can be stored in the data storage device, wherein at least one item of pressure distribution information defines a pressure distribution during the filling of the molding tool cavity with the expandable or expanded particle foam material, and/or at least one item of pressure distribution information defines a pressure distribution while carrying out the at least one measure for introducing, in a vapor-free manner, thermal energy into the particle foam material filled into the molding tool cavity for forming a particle foam preform, and/or at least one item of pressure distribution information defines a pressure distribution while carrying out the at least one measure for cooling a particle foam preform the molding tool cavity, and/or at least one item of pressure distribution information defines a pressure distribution while demolding the particle foam preform from the molding tool cavity.

As mentioned, all that has been stated in connection with the method according to the first aspect of the invention applies analogously for the device according to the second aspect of the invention.

The invention is explained again in the following with reference to the embodiments shown in the figures, in which:

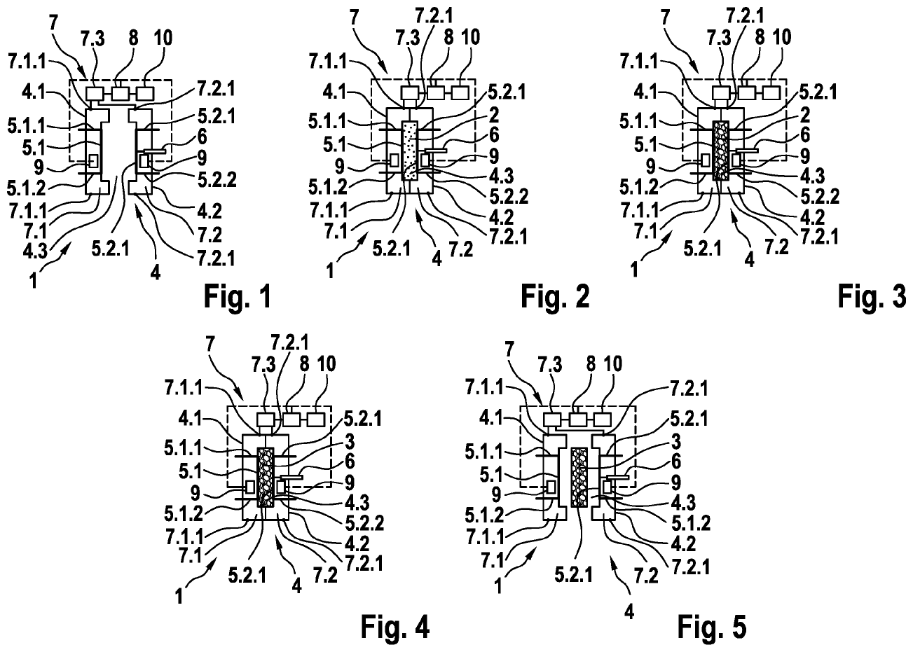

FIG. 1-5 are each schematic views of a device for the vapor-free processing of particle foam material for carrying out a method according to an embodiment; and

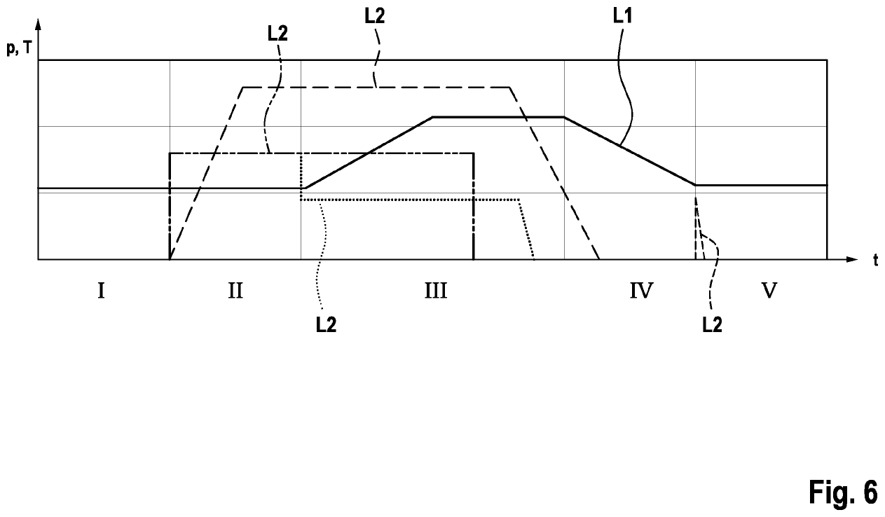

FIG. 6 is a schematic view of a pressure distribution in the molding tool cavity while carrying out a method according to an embodiment.

FIG. 1-5 are each schematic views of a device 1 for the vapor-free and thus dry processing of particle foam material 2 (cf. e.g. FIG. 2) for producing a particle foam preform 3 (cf. e.g. FIGS. 4, 5), which is configured for carrying out a method according to an embodiment.

The device 1 comprises a molding tool 4 configured for vapor-free and thus dry processing of particle foam material 2. In the embodiment, the molding tool 4 comprises two molding tool elements 4.1, 4.2, which define the molding tool cavity 4.3 of the molding tool 4. The molding tool elements 4.1, 4.2, which can optionally also be referred to as a molding tool wall or molding tool wall portion, are mounted so as to be movable inro an open position, shown by way of example in FIGS. 1, 5, in which, e.g. for the purpose of removing a produced particle foam preform 3, there is a possibility of access into the molding tool cavity 4.3, and into a closed position, shown by way of example in FIG. 2-4 , in which—apart from possibly required small required openings e.g. for ventilation-there is no possibility of access into the molding tool cavity 4.3. Therefore, at least one molding tool element 4.1, 4.2 is mounted so as to be movable relative to at least one other molding tool element 4.1, 4.2, by means of a drive device (not shown), in order to achieve a corresponding open and closed position.

The molding tool 4 is configured for vapor-free and thus dry processing of particle foam material 2. The molding tool 4 is accordingly associated with a temperature-control device 5 which is configured to introduce the thermal energy, required for connecting the particle foam material 2 to form the particle foam preform 3, into the particle foam material 2 conductively, in particular exclusively conductively, or in a mixed conductive/convective manner, in particular exclusively in a mixed conductive/convective manner, and thus in any case without the use of superheated steam flowing through the molding tool cavity 4.3. The molding tool 4 correspondingly does not have a vapor chamber, in which superheated steam can be kept for flowing through the molding tool cavity 4.3. The wall portions of the molding tool elements 4.1, 4.2 defining the molding tool cavity 4.3 thus likewise do not have any passage openings for the passage of superheated steam into the molding tool cavity 4.3.

In the embodiment, the temperature-control device 5 is formed by or comprises a flow channel structure 5.1, 5.2 (indicated purely schematically in FIG. 1 as a line in the region of the wall portions of the molding tool elements 4.1, 4.2 defining the molding tool cavity 4.3) through which a temperature-control medium, i.e. e.g. a gas and/or a liquid, van flow. It can be seen that each molding tool element 4.1, 4.2 can comprise a corresponding flow channel structure 5.1, 5.2 which can in each case be connected to a temperature-control medium supply (not shown) via supply lines 5.1.1, 5.2.1 and discharge lines 5.1.2, 5.2.2. A corresponding flow channel structure 5.1, 5.2 can comprise one or more flow channels (not shown) which extend in one or more spatial planes and/or directions outside or inside the respective molding tool element 4.1, 4.2. An, optionally pressurized, temperature-control medium can flow through a corresponding flow channel structure 5.1, 5.2, which results in temperature control of the wall portions of the molding tool elements 4.1, 4.2 defining the molding tool cavity 4.3, such that thermal energy can be transferred into the molding tool cavity 4.3 and thus to the particle foam material 2 located in the molding tool cavity 4.3 via the wall portions of the molding tool elements 4.1, 4.2 defining the molding tool cavity 4.3. Depending on the temperature level of the temperature-control medium, the molding tool cavity 4.3 or the particle foam material can be heated (cf. FIG. 3) or, this applies in particular for a previously heated molding tool cavity 4.3, cooled (cf. FIG. 4), in this way. Therefore, the at least one measure for introducing, in a vapor-free manner, thermal energy into the particle foam material 2 filled into the molding tool cavity 4.3 for forming a particle foam preform 3, which is described in more detail below and is carried out in the context of the method, can be carried out by means of a heated temperature-control medium flowing through a flow channel structure 5.1, 5.2.

The flow channels of a corresponding flow channel structure 5.1, 5.2 can be formed by one or more channel-like or channel-shaped recesses formed in one or more spatial planes and/or directions through respective wall portions of the molding tool elements 4.1, 4.2 defining the molding tool cavity 4.3. Alternatively or in addition, the flow channels can be formed by one or more separate line elements which are in particular configured in one or more spatial planes and/or directions, are one-dimensional or multidimensional, and through which a temperature-control medium can flow, i.e. e.g. pipe or tube elements, which are arranged at or in at least one wall portion of a respective molding tool element 4.1, 4.2 that defines the molding tool cavity 4.3.

The molding tool 4 is furthermore associated with a filling device 6 which is configured for filling the molding tool cavity 4.3 with particle foam material 2. A corresponding filling device 6 can e.g. be configured for generating an, optionally pressurized, conveying stream, i.e. in particular a gas stream, via which the particle foam material 2 is conveyed, optionally pressurized, from a particle foam material reservoir (not shown) into the molding tool cavity 4.3 (cf. FIG. 2). As indicated in FIG. 1-5, a corresponding filling device 6 can thus comprise one or more filling portions (not labelled) which communicate with the molding tool cavity 4.3 and via which particle foam material 2 can be conveyed into the molding tool cavity 4.3.

As emerges in the following, the molding tool 4 is furthermore associated with a pressure control device, which is configured for controlling the pressure or the pressure level within the molding tool cavity 4.3 independently of the temperature control of the molding tool cavity 4.3 via the temperature-control device 5. As mentioned, this is to be understood as the gas pressure or the gas pressure level within the molding tool cavity 4.3.

A corresponding pressure control device can, as indicated in FIG. 1-5 , comprise e.g. a pressure reservoir 7.3 filled with a pressurized pressure medium, in particular a pressurized gas, e.g. compressed air, and pressure chambers 7 that communicate therewith and are associated with the molding tool cavity 4.3, in particular surround the molding tool cavity 4.3 at least in portions, optionally completely (with their pressure chamber halves 7.1 and 7.2, by way of example). In the embodiment, each molding tool element 4.1, 4.2 is associated, by way of example, with a corresponding pressure chamber half 7.1, 7.2. A corresponding pressure chamber 7 or pressure chamber half 7.1, 7.2 can communicate with the molding tool cavity 4.3 e.g. via one or more openings (these can optionally also be implemented by porous wall portions), such that a pressure level prevailing within the pressure chamber 7 or pressure chamber half 7.1, 7.2 can be transferred to the molding tool cavity 4.3 and thus the particle foam material 2 filled into the molding tool cavity 4.3. The pressure chamber 7 or the respective pressure chamber halves 7.1, 7.2 can comprise one or more, in particular valve-like or valve-shaped, pressure control elements 7.1.1, 7.2.1, which are configured for controlling an inflow of the or a pressurized pressure medium into the pressure chamber 7 or into respective pressure chamber halves 7.1, 7.2, and/or for controlling an outflow of the or a pressurized pressure medium out of the pressure chamber 7 or out of respective pressure chamber halves 7.1, 7.2. Respective pressure control elements 7.1.1, 7.2.1 can be transferred into at least one open position in which an inflow of a pressurized pressure medium into the pressure chamber 7 or or into respective pressure chamber halves 7.1, 7.2, or an outflow of a pressurized pressure medium out of the pressure chamber 7 or or out of respective pressure chamber halves 7.1, 7.2 is possible, and into at least one closed position, in which an inflow of a pressurized pressure medium into the pressure chamber 7 or into respective pressure chamber halves 7.1, 7.2, or an outflow of a pressurized pressure medium out of the pressure chamber 7 or out of respective pressure chamber halves 7.1, 7.2 is not possible. Furthermore, at least one intermediate position located between a respective open position and a respective closed position can be implemented, such that pressure media flows and pressure levels, which optionally vary in a time-dependent manner, can be set in a very purposeful manner in the pressure chamber 7 or in respective pressure chamber halves 7.1, 7.2.

As is also explained in more detail below, the pressure control device is associated with a controller 8 which is implemented by hardware and/or software and which is configured for controlling the operation of the pressure control device and thus the pressure level within the pressure chamber 7 or within respective pressure chamber halves 7.1, 7.2 and thus within the molding tool cavity 4.3.

As mentioned, the device 1 for the vapor-free processing of particle foam material 2 is configured for carrying out a method according to an embodiment, the steps of which method are explained in detail in the following:

The method comprises a step of filling the molding tool cavity 4.3 of the molding tool 4 with an expandable or expanded particle foam material 2. The filling of the molding tool cavity 4.3 of the molding tool 4 with particle foam material 2 is carried out using the filling device 6. The step of filling the molding tool cavity 4.3 with particle foam material 2 is represented in the flow diagram, shown as a schematic view in FIG. 6, in the process portion denoted “II”, which is clearly preceded by a process step, denoted by “I”, of closing the molding tool 4.

The method further comprises a step of carrying out at least one measure for introducing, in a vapor-free manner, thermal energy into the particle foam material 2 filled into the molding tool cavity 4.3 in process portion II for forming a particle foam preform 3 (cf. FIG. 3). This process step is denoted by “III” in the flow diagram shown in FIG. 6. Accordingly, so much thermal energy is introduced conductively or in a mixed conductive/convective manner, via the at least one measure, into the particle foam material 2 filled into the molding tool cavity 4.3, that the plastics particles are interconnected, in particular by what is known as fusing, forming the particle foam preform 3 to be produced. The at least one measure for introducing, in a vapor-free manner, thermal energy into the particle foam material 2 filled into the molding tool cavity 4.3 for forming a particle foam preform 3 is carried out by means of the temperature-control device 5. It is clear on the basis of FIG. 6 that the temperature indicated by way of example by the line L1, within the molding tool cavity 4.3, is increased in the process step III by corresponding operation of the temperature-control device 5 and then held at a temperature level.

The method further comprises a step of carrying out at least one measure for cooling the particle foam preform 2 in the molding tool cavity 4.3 (cf. FIG. 4). This process step is denoted by “IV” in the flow diagram shown in FIG. 6. The at least one measure for cooling the particle foam preform 3 in the molding tool cavity 4.3 can likewise be carried out by means of the temperature-control device 5 in that a (comparatively) cool temperature-control medium flows through at least one flow channel structure 5.1, 5.2. It is clear on the basis of FIG. 6 that the temperature indicated by the line L1, within the molding tool cavity 4.3, is reduced in the process step IV by corresponding operation of the temperature-control device 5.

For the sake of completeness, it is noted that the method finally comprises a step of demolding the particle foam preform 3 from the molding tool 4 (cf. FIG. 5). This process step is denoted by “V” in the flow diagram shown in FIG. 6.

It is essential for the method that it should contain a step of carrying out at least one measure for controlling (the term “controlling” can also include “regulating”) the pressure (cf. the lines L2 by way of example in FIG. 6) in the molding tool cavity 4.3 during the filling of the molding tool cavity 4.3 with the particle foam material 2 (cf. process step II) and/or while carrying out the at least one measure for introducing, in a vapor-free manner, thermal energy into the particle foam material 2 filled into the molding tool cavity 4.3 for forming the particle foam preform 3 (cf. process step III) and/or while carrying out the at least one measure for cooling the particle foam preform 3 in the molding tool cavity 4.3 (cf. process step IV) and/or during the demolding of the particle foam preform 3 from the molding tool cavity 4.3 (cf. process step V). The at least one measure for controlling the pressure in the molding tool cavity 4.3 during the respective process steps II-V is carried out by means of the pressure control device and thus independently of the operation of the temperature-control device 5. It is therefore possible and also purposely provided according to the method, in particular during one or more of the process steps II-V, to control the pressure within the molding tool cavity 4.3 independently of the temperature within the molding tool cavity 4.3 (and vice versa). The carrying out of the at least one measure for controlling the pressure in the molding tool cavity 4.3 thus takes place, according to the method, in particular independently of the carrying out of the at least one measure for introducing, in a vapor-free manner, thermal energy into the particle foam material 2 filled into the molding tool cavity 4.3 for forming a particle foam preform 3 according to process step III, even if the carrying out of the at least one measure for controlling the pressure in the molding tool cavity 4.3 and the carrying out of the at least one measure for introducing, in a vapor-free manner, thermal energy into the particle foam material 2 filled into the molding tool cavity 4.3 for forming a particle foam preform 3, as illustrated by way of example in FIG. 6, can take place at least sometimes in parallel.

The method is thus characterized by the possibility, which can be or is achieved by means of the pressure control device, of purposely creating and maintaining particular pressure levels within the molding tool cavity 4.3, irrespective of the temperature within the molding tool cavity 4.3. As can be seen on the basis of the lines L2 in FIG. 6 showing various pressure distributions, by way of example, within the molding tool cavity 4.3, according to the method it is possible for particular pressure changes or distributions to be purposely created and maintained within the molding tool cavity 4.3 irrespective of the temperature within the molding tool cavity 4.3, in particular in a time-dependent manner, which surprisingly has an extremely positive effect on the processes (cf. process steps II-V) occurring within the molding tool cavity 4.3, in the context of the method. In other words, the purposeful setting of corresponding pressure levels or distributions, which optionally vary in a process-dependent and thus time-dependent manner, makes it possible to purposely influence the processes occurring within the molding tool cavity 4.3 in the context of the method, and thus the properties of the particle foam preform 3 to be produced. The possibility, which can be or is achieved by means of the pressure control device, of purposely creating and maintaining particular pressure levels or distributions within the molding tool cavity 4.3, irrespective of the temperature within the molding tool cavity 4.3, thus opens entirely new possibilities of process control, which has a positive effect on the efficiency and controllability of the method and on the quality of the particle foam preforms 3 that can be produced according to the method.

The at least one measure for introducing, in a vapor-free manner, thermal energy into the molding tool cavity 4.3 can take place already before and/or during the filling of the molding tool cavity 4.3. Therefore, the molding tool cavity 4.3 can be thermally preconditioned by the introduction, in a vapor-free manner, of thermal energy already before and/or during the filling, which can have a positive effect on the filling process and/or the subsequent temperature-control process, and thus on the properties of the particle foam preform 3 that is to be produced or that has been produced. The at least one measure for introducing, in a vapor-free manner, thermal energy into the molding tool cavity 4.3 can be carried out before and/or during the filling of the molding tool cavity 4.3, e.g. by means of the temperature-control device 5.

Alternatively or in addition, a temperature control of a conveying stream, by means of which the particle foam material 2 is conveyed into the molding tool cavity 4.3, is conceivable.

It should likewise be mentioned that the pressure medium provided via the pressure control device can also be temperature-controlled, such that thermal energy can also be introduced into the molding tool cavity 4.3 via the pressure medium, in addition to, although independently of, the actual measures for introducing thermal energy into the particle foam material 2, for example for preconditioning the particle foam material 2. The at least one measure for controlling the pressure in the molding tool cavity 4.3 can accordingly include at least intermittently introducing a pressurized pressure medium, which is temperature-controlled by means of an active or passive temperature-control measure to a heating or cooling temperature, into the molding tool cavity 4.3. The temperature-control measure can be carried out by at least one temperature-control device (not shown) that is associated with the pressure control device. This is typically a temperature-control device that is separate from the temperature-control device 5 associated with the molding tool 4.

As indicated, the controller 8 is configured for controlling the operation of the pressure control device and thus the pressure level within the molding tool cavity 4.3. The carrying out of the at least one measure for controlling the pressure in the molding tool cavity 4.3 is thus carried out on the basis of control information generated by the controller 8, which allows for accurate and reproducible and individualizable control of the pressure level within the molding tool cavity 4.3.

The method can optionally further contain a step of detecting at least one chemical and/or physical parameter, i.e. in particular the pressure, the temperature, the composition of the chemical atmosphere, within the molding tool cavity 4.3, and of generating an item of detection information describing the at least one detected one chemical and/or physical parameter within the molding tool cavity 4.3. The step of detecting at least one chemical and/or physical parameter within the molding tool cavity and of generating an item of detection information describing the at least one detected one chemical and/or physical parameter within the molding tool cavity can be carried out by means of a detection device 9 associated with the molding tool cavity 4.3. A corresponding detection device 9 can comprise one or more detection elements (not shown), i.e. e.g. sensor elements, e.g. pressure sensor elements, temperature sensor elements, etc., arranged or formed on or in the molding tool 4, the detection signals of which can be described by the detection device 9 in corresponding detection information, which can be used for controlling the method.

Corresponding detection information can accordingly be used e.g. by the controller 8 for controlling the operation of the pressure control device and thus of the pressure level within the molding tool cavity 4.3. The controller 8 can accordingly generate the control information that controls the operation of the pressure control device on the basis of or taking account of the detection information.

It has been mentioned that the method makes it possible, by means of the pressure control device and the pressure management, implementable thereby, in the molding tool cavity 4.3, to purposely create and maintain particular pressure levels or pressure distributions within the molding tool cavity 4.3 independently of all the measures for temperature-control of the molding tool cavity 4.3 and thus of the particle foam material 2 located therein.

This can be achieved e.g. such that the controller 8 generates corresponding control information for controlling the operation of the pressure control device on the basis of pressure distribution information stored in a data storage device 10, e.g. implemented as a server, which information in each case defines a defined pressure distribution, i.e. in particular a defined gas or air pressure distribution, within the molding tool cavity 4.3. Therefore, the controller 8 can have recourse to predefined pressure distribution information for controlling the operation of the pressure control device, which can reduce the complexity for the control of the operation of the pressure control device. Corresponding pressure distribution information may have been generated on the basis of information from databases, experiments, simulations, etc. Corresponding defined pressure distributions can—as can be seen by way of example in FIG. 6 from the lines L2—describe in particular profile-like or profile-shaped pressure distributions, more particularly pressure distributions that rise or fall in a ramp-like or ramp-shaped manner, and/or, in particular plateau-like or plateau-shaped, pressure levels. In particular, respective defined pressure distributions can accordingly describe pressure levels that vary in a time-dependent manner.

Each pressure distribution can thus define an, e.g. time-dependent, change in a pressure level in the molding tool cavity 4.3 and/or an, e.g. time-dependent, maintenance of a pressure level in the molding tool cavity 4.3. An, e.g. time-dependent, change in a pressure level in the molding tool cavity 4.3 can define an increase in a pressure level, i.e. in particular an initial pressure level to a comparatively higher target pressure level, and/or a drop in a pressure level, i.e. in particular an initial pressure level to a comparatively lower target pressure level. Each pressure distribution can accordingly define a curve of a pressure level within the molding tool cavity 4.3 that is predefinable or predefined, in particular time-dependent, in particular that can be described by a mathematical function. As mentioned, different pressure distributions are shown by way of example in FIG. 6 by the lines L2.

Corresponding pressure distribution information can be stored in the data storage device 10 e.g. in a manner ordered or categorized in a material and/or molding tool and/or preform-specific manner, such that e.g. particle foam materials 2 that are to be processed differently, and/or molding tools 4 that are configured differently e.g. with respect to the volume of the molding tool cavity 4.3, and/or particle foam preforms 3 that are configured differently e.g. with respect to their geometric/structural configuration, can be assigned predefined pressure distribution information. In this way, material and/or molding tool and/or preform-specific differences can be considered when applying corresponding pressure distributions, and thus highly individualized or tailored pressure levels or pressure distributions can be implemented in view of a with a specific particle foam material 2 in a specific molding tool 4 for producing a specific particle foam preform 3.

Pressure distribution information which describes a defined pressure level in the molding tool cavity 4.3, which can optionally vary in a time-dependent manner, for a complete production process of a particle foam preform 3, can be stored in the data storage device 10, such that a (single) item of pressure distribution information defines the pressure level within the molding tool cavity 4.3, which can optionally vary in a time-dependent manner, for a complete method procedure (which would contain the process steps I-V in the flow diagram according to FIG. 6) for producing a particle foam preform 3. Accordingly, at least one item of pressure distribution information can be stored in the data storage device 10, which defines a pressure distribution during the filling of the molding tool cavity 4.3 with the particle foam material 2, while carrying out the at least one measure for introducing, in a vapor-free manner, thermal energy into the particle foam material 2 filled into the molding tool cavity 4.3 for forming a particle foam preform 3, while carrying out the at least one measure for cooling the particle foam preform 3 in the molding tool cavity 4.3, and while demolding the particle foam preform 3 from the molding tool cavity 4.3.

In order to optionally achieve a higher level of granularity with respect to a setting of a pressure level in the molding tool cavity 4.3 that is optimized in a process-dependent manner, separate pressure distribution information can be stored in the data storage device 10 for individual ones of, a plurality of or all of the processes or process steps, cf. the process steps I-V in the flow diagram of FIG. 6, within the method. Accordingly, a plurality of separate items of pressure distribution information can be stored in the data storage device 10, wherein at least one item of pressure distribution information defines a pressure distribution during the filling of the molding tool cavity 4.3 with the particle foam material 2, and/or at least one item of pressure distribution information defines a pressure distribution while carrying out the at least one measure for introducing, in a vapor-free manner, thermal energy into the particle foam material 2 filled into the molding tool cavity 4.3 for forming a particle foam preform 3, and/or at least one item of pressure distribution information defines a pressure distribution while carrying out the at least one measure for cooling a particle foam preform 3 in the molding tool cavity 4.3, and/or at least one item of pressure distribution information defines a pressure distribution while demolding a particle foam preform 3 from the molding tool cavity 4.3.

Accordingly, at least one item of pressure distribution information can be stored in the data storage device 10 (and be used by the pressure control device for controlling the pressure within the molding tool cavity 4.3), which defines a pressure distribution during the filling of the molding tool cavity 4.3 with the particle foam material 2, which results in compression of the particle foam material 2 filled into the molding tool cavity 4.3. The pressure distribution can, as shown by way of example in FIG. 6, define a first pressure level that is increased with respect to a reference pressure, e.g. atmospheric pressure, which pressure level is to be maintained during the filling of the molding tool cavity 4.3 with the particle foam material 2. The compression of the particle foam material 2 resulting from the increased pressure makes it possible for higher filling levels of the molding tool cavity 4.3 to be achieved, which can e.g. have a positive effect on the properties of a particle foam preform 3 to be produced. As emerges in the following, higher filling levels of the molding tool cavity 4.3 can, however, also have a positive effect on the process of binding the plastics particles for forming a particle foam preform 3, which process follows the filling of the molding tool cavity 4.3, as the plastics particles contact one another more strongly “by necessity”.

Alternatively or in addition, at least one item of pressure distribution information can be stored in the data storage device 10 (and can be used by the pressure control device for controlling the pressure within the molding tool cavity 4.3), which defines a pressure distribution while carrying out the at least one measure for introducing, in a vapor-free manner, thermal energy into the particle foam material 2 filled into the molding tool cavity 4.3 for forming a particle foam preform 3, which results in expansion of the particle foam material 2 filled into the molding tool cavity 4.3. The pressure distribution can, as shown by the dashed line L2 in FIG. 6, define a second pressure level that is increased with respect to a reference pressure, e.g. atmospheric pressure, but reduced with respect to the first pressure level (during the filling of the molding tool cavity 4.3), which second pressure level is to be maintained while carrying out the at least one method for introducing, in a vapor-free manner, thermal energy into the particle foam material 2 filled into the molding tool cavity 4.3 for forming a particle foam preform 3. The expansion of the particle foam material 2 makes it possible for the contact surfaces and thus the surfaces for transmitting thermal energy between the individual plastics particles to be improved, as adjacent plastics particles press against one another due to expansion. This leads to an improved connection and fusing of the plastics particles, and thus to improved properties of the particle foam preform 3 that is to be produced or has been produced. As indicated, the expansion brought about by a corresponding second pressure level can expediently be preceded by a compression of the plastics particles brought about by a corresponding first pressure level. The second pressure level can also serve, during processing of particle foam material 2 loaded with a chemical and/or physical propellant, for preventing undesired escape of the propellant or for reducing this, in particular in a pressure-controlled manner.

Alternatively or in addition, at least one item of pressure distribution information can be stored in the data storage device 10 (and can be used by the pressure control device for controlling the pressure within the molding tool cavity 4.3), which defines a pressure distribution while carrying out the at least one measure for cooling the particle foam preform 3 in the molding tool cavity 4.3, which results in targeted cooling of the particle foam preform 3, in particular targeted formation of a defined microstructure of the particle foam preform 3, more particularly in the formation of a purposeful size and/or morphology of the plastics particles that are interconnected to form the particle foam preform 3. The pressure distribution can include at least one pressure level that is increased and/or reduced with respect to the second pressure level, such that the plastics particles can optionally compressed again or (further) expanded during cooling, which results in various possibilities for setting a defined microstructure of the particle foam preform 2.

Alternatively or in addition, at least one item of pressure distribution information can be stored in the data storage device 10 (and can be used by the pressure control device for controlling the pressure within the molding tool cavity), which defines a pressure distribution while demolding the particle foam preform 3 from the molding tool cavity 4.3, which results in demolding or simplified demolding of the particle foam preform 3 from the, optionally open, molding tool cavity 4.3. A corresponding pressure distribution can, as indicated in FIG. 6 in process step V, cause e.g. an in particular ramp-like pressure increase within the molding tool cavity 4.3, in order to release the particle foam preform 3 from the wall portions of the molding tool elements 4.1, 4.2 that define the molding tool cavity 4.3. Specifically, a brief, abrupt pressure increase is shown by way of example in FIG. 6, which makes it possible to release the particle foam preform 3 more easily and/or more quickly from the wall portions of the molding tool elements 4.1, 4.2 that define the molding tool cavity 4.3.

1. A method for vapor-free processing of expandable or expanded particle foam material for producing a particle foam preform in a molding tool cavity of a molding tool, comprising the steps of:
filling a molding tool cavity of a molding tool for vapor-free processing of expandable or expanded particle foam material with an expandable or expanded particle foam material;
carrying out at least one measure for introducing, in a vapor-free manner, thermal energy into the particle foam material filled into the molding tool cavity for forming a particle foam preform by means of a temperature-control device associated with the molding tool,
carrying out at least one measure for cooling the particle foam preform in the molding tool cavity by means of the or a temperature-control device associated with the molding tool, wherein:
carrying out at least one measure for controlling the pressure, in the molding tool cavity during the filling of the molding tool cavity with the expandable or expanded particle foam material and/or while carrying out the at least one measure for introducing, in a vapor-free manner, thermal energy into the particle foam material filled into the molding tool cavity for forming a particle foam preform and/or while carrying out the at least one measure for cooling the particle foam preform in the molding tool cavity by means of the or a temperature-control device associated with the molding tool, by means of a pressure control device associated with the molding tool, wherein
the carrying out of the at least one measure for controlling the pressure in the molding tool cavity takes place independently of the carrying out of the at least one measure for introducing, in a vapor-free manner, thermal energy into the particle foam material filled into the molding tool cavity for forming a particle foam preform and/or independently of the carrying out of the at least one measure for cooling the particle foam preform in the molding tool cavity.

2. The method according to claim 1, further comprising carrying out at least one measure for introducing, in a vapor-free manner, thermal energy into the molding tool cavity before and/or during the filling of the molding tool cavity with the particle foam material by means of a temperature-control device associated with the molding tool.

3. The method according to claim 1, wherein the at least one measure for controlling the pressure in the molding tool cavity includes introducing and/or removing or releasing a pressurized pressure medium into or out of the molding tool cavity.

4. The method according to claim 3, wherein the at least one measure for controlling the pressure in the molding tool cavity includes at least intermittently introducing and/or removing or releasing a pressurized pressure medium, which is temperature-controlled by means of an active or passive temperature-control measure to a heating or cooling temperature, into or out of the molding tool cavity.

5. The method according to claim 1, wherein the carrying out of the at least one measure for controlling the pressure in the molding tool cavity is carried out on the basis of control information generated by a controller.

6. The method according to claim 1, further comprising detecting, by means of a detection device associated with the molding tool cavity, at least one chemical and/or physical parameter within the molding tool cavity and generating detection information that describes the at least one detected chemical and/or physical parameter within the molding tool cavity, wherein the controller generates the control information on the basis of or taking account of the detection information.

7. The method according to claim 5, wherein the controller generates the control information on the basis of pressure distribution information stored in a data storage device, which in each case defines a profile-like or profile-shaped, pressure distribution within the molding tool cavity.

8. The method according to claim 7, wherein at least one item of pressure distribution information is stored in the data storage device, which defines a pressure distribution during the filling during the molding tool cavity with particle foam material, while carrying out the at least one measure for introducing, in a vapor-free manner, thermal energy into the particle foam material filled into the molding tool cavity for forming a particle foam preform, while carrying out the at least one measure for cooling the particle foam preform in the molding tool cavity, and while demolding the particle foam preform from the molding tool cavity; and/or
a plurality of separate items of pressure distribution information are stored in the data storage device, wherein at least one item of pressure distribution information defines a pressure distribution during the filling of the molding tool cavity with a particle foam material, and/or at least one item of pressure distribution information defines a pressure distribution while carrying out the at least one measure for introducing, in a vapor-free manner, thermal energy into the particle foam material filled into the molding tool cavity for forming a particle foam preform, and/or at least one item of pressure distribution information defines a pressure distribution while carrying out the at least one measure for cooling the particle foam preform in the molding tool cavity, and/or at least one item of pressure distribution information defines a pressure distribution while demolding the particle foam preform from the molding tool cavity.

9. The method according to claim 8, wherein at least one item of pressure distribution information is stored in the data storage device, which defines a pressure distribution during the filling of the molding tool cavity with the expandable or expanded particle foam material, which results in compression of the particle foam material filled into the molding tool cavity.

10. The method according to either claim 8, wherein at least one item of pressure distribution information is stored in the data storage device, which defines a pressure distribution while carrying out the at least one measure for introducing, in a vapor-free manner, thermal energy into the particle foam material filled into the molding tool cavity for forming a particle foam preform, which results in expansion of the particle foam material filled into the molding tool cavity.

11. The method according to claim 8, wherein at least one item of pressure distribution information is stored in the data storage device, which defines a pressure distribution while carrying out the at least one measure for cooling the particle foam preform in the molding tool cavity, which results in targeted cooling of the particle foam preform in formation of a targeted microstructure or cell structure of the particle foam preform.

12. The method according to claim 8, wherein at least one item of pressure distribution information is stored in the data storage device, which defines a pressure distribution while demolding the particle foam preform from the molding tool cavity, which results in demolding or simplified demolding of the particle foam preform from the molding tool cavity.

13. The method according to claim 1, wherein a pressure control device is used which comprises a pressure reservoir filled with a pressurized pressure medium, and at least one pressure chamber associated with the molding tool cavity and surrounding said cavity at least in portions.

14. The method according to claim 1, wherein a molding tool comprising a temperature-control device is used, which comprises at least one flow channel through which a temperature-control medium can flow.

15. A device for vapor-free processing of expandable or expanded particle foam material for producing a particle foam preform according to the method according to claim 1, comprising:
a molding tool, defining a molding tool cavity, for vapor-free processing of expandable or expanded particle foam material,
a filling device associated with the molding tool, which is configured for filling the molding tool cavity with an expandable or expanded particle foam material;
at least one temperature-control device associated with the molding tool, which is configured for carrying out at least one measure for introducing, in a vapor-free manner, thermal energy into the particle foam material filled into the molding tool cavity for forming a particle foam preform, and/or for carrying out at least one measure for cooling a particle foam preform in the molding tool cavity, wherein:
a pressure control device associated with the molding tool, which is configured for carrying out at least one measure for controlling the pressure, in the molding tool cavity during the filling of the molding tool cavity with particle foam material and/or while carrying out the at least one measure for introducing, in a vapor-free manner, thermal energy into the particle foam material filled into the molding tool cavity for forming a particle foam preform and/or while carrying out the at least one measure for cooling the particle foam preform in the molding tool cavity, wherein:
the pressure control device is configured to implement the carrying out of the at least one measure for controlling the pressure in the molding tool cavity independently of the carrying out of the at least one measure for introducing, in a vapor-free manner, thermal energy into the particle foam material filled into the molding tool cavity for forming a particle foam preform and/or independently of the carrying out of the at least one measure for cooling the particle foam preform in the molding tool cavity.

16. The device according to claim 15, wherein a pressure control device comprises a pressure reservoir filled with a pressurized pressure medium, and at least one pressure chamber that communicates therewith and is associated with the molding tool cavity and surrounds the molding tool cavity at least in portions.

17. The device according to claim 16, wherein the at least one pressure chamber communicates with the molding tool cavity such that a pressure level prevailing in the at least one pressure chamber can be transferred to the molding tool cavity.

18. The device according to claim 15, further comprising a controller which is configured for generating control information for controlling the operation of the pressure control device.

19. The device according to claim 15, further comprising a detection device which is configured for detecting at least one chemical and/or physical parameter within the molding tool cavity and for generating detection information that describes the at least one detected chemical and/or physical parameter within the molding tool cavity, wherein the or a controller is configured for generating control information for controlling the operation of the pressure control device on the basis of or taking account of the detection information.

20. The device according to claim 15, further comprising a data storage device in which pressure distribution information, which in each case defines a profile-like or profile-shaped pressure distribution within the molding tool cavity, is stored.

21. The device according to claim 20, wherein at least one item of pressure distribution information is stored in the data storage device, which defines a pressure distribution during the filling during the molding tool cavity with particle foam material, while carrying out the at least one measure for introducing, in a vapor-free manner, thermal energy into the particle foam material filled into the molding tool cavity for forming a particle foam preform, while carrying out the at least one measure for cooling the particle foam preform in the molding tool cavity, and while demolding the particle foam preform from the molding tool cavity; and/or a plurality of separate items of pressure distribution information is stored in the data storage device, wherein at least one item of pressure distribution information defines a pressure distribution during the filling of the molding tool cavity with particle foam material, and/or at least one item of pressure distribution information defines a pressure distribution while carrying out the at least one measure for introducing, in a vapor-free manner, thermal energy into the particle foam material filled into the molding tool cavity for forming a particle foam preform, and/or at least one item of pressure distribution information defines a pressure distribution while carrying out the at least one measure for cooling a particle foam preform in the molding tool cavity, and/or at least one item of pressure distribution information defines a pressure distribution while demolding a particle foam preform from the molding tool cavity.
